(19) United States
(12) Patent Application Publication
(10) Pub. No.: US 2026/0254281 A1
(43) Pub. Date: Aug. 27, 2026

(54) WIRELESS AREA MOBILE CHARGING STATION AND METHOD OF USE

(71) Applicants: D'Anthony Bell, Orlando, FL (US); Shelton Lewis, Orlando, FL (US)

(72) Inventors: D'Anthony Bell, Orlando, FL (US); Shelton Lewis, Orlando, FL (US)

(21) Appl. No.: 19/549,484

(22) Filed: Feb. 25, 2026

Related U.S. Application Data
(60) Provisional application No. 63/762,822, filed on Feb. 25, 2025.

(51) Int. Cl. H02J 50/40; H02J 50/00; H02J 50/20; H02J 50/80; H02J 50/90

(52) U.S. Cl. CPC H02J 50/402; H02J 50/005; H02J 50/20; H02J 50/80; H02J 50/90

(57) ABSTRACT

A wireless area mobile charging station. The station includes a housing configured for placement within an enclosed space, a power module configured to receive and regulate electrical power from an external power source, a wireless energy transmission module configured to generate wireless electromagnetic energy, and one or more antennas configured to radiate the electromagnetic energy to establish a wireless charging region (i.e., field). A control module manages operation of the wireless energy transmission module such that a plurality of electronic devices automatically (i.e., autonomously) receive wireless electrical power for charging when positioned within the wireless charging region without requiring physical contact, wired connections, or user interaction. A method of operating the station includes initializing wireless energy transmission, detecting compatible electronic devices within the wireless charging region, authorizing energy delivery, modulating transmission parameters, and managing idle operation.

### CROSS-REFERENCE TO RELATED APPLICATION

The present application claims priority to, and the benefit of, U.S. Provisional Application No. 63/762,822 which was filed on Feb. 25, 2025 and is incorporated herein by reference in its entirety.

### FIELD OF THE INVENTION

The present invention generally relates to wireless power transmission systems for charging electronic devices. More specifically, the present invention relates to a wireless area mobile charging system configured to automatically (i.e., autonomously) supply electrical power to multiple electronic devices within an enclosed space without requiring physical contact, wired connections, or user interaction. The invention comprises a charging station having a housing configured for placement within a room and enclosing a power module, a wireless energy transmission module, and a control module. One or more antennas are operatively coupled to the wireless energy transmission module to radiate electromagnetic energy and establish a three-dimensional wireless charging region (i.e., field) extending outwardly from the charging station. Compatible electronic devices positioned within the wireless charging region (i.e., field) automatically (i.e., autonomously) receive wireless electrical power for charging, and in certain embodiments the charging region (i.e., field) extends through walls or partitions to enable charging across adjacent rooms. Accordingly, the present disclosure makes specific reference thereto. Nonetheless, it is to be appreciated that aspects of the present invention are also equally applicable to other like applications, devices, and methods of manufacture.

### BACKGROUND

By way of background, handheld electronic devices such as smartphones, tablets, and wearable devices have become essential tools for communication, productivity, and access to information. Such devices use internal batteries that require periodic recharging, and users are often dependent on access to electrical outlets and compatible charging accessories to maintain device operation. In many situations, such as when users are away from home or traveling between locations, access to an electrical outlet or a personal charging cable can be limited or unavailable.

When a mobile device loses battery power under such circumstances, users can be unable to place or receive important phone calls, messages, or electronic communications, resulting in inconvenience and disruption. Although wireless charging technologies have been developed to reduce reliance on wired connections, many existing wireless charging solutions are limited in functionality. For example, current wireless charging units typically support charging of only a single device at a time and often require precise placement or direct contact with a charging surface.

The limitations reduce the practicality of existing wireless charging systems in shared or high-traffic environments, including offices, retail establishments, restaurants, and other public or commercial spaces where multiple users may require charging simultaneously. Accordingly, individuals desire improved wireless charging solutions that overcome the limitations of conventional systems and provide greater convenience and accessibility for users.

Therefore, there exists a long-felt need in the art for an improved charging solution that overcomes the limitations of conventional wired and pad-based charging systems. There is a long-felt need in the art for a charging system that does not require users to locate an electrical outlet or carry personal charging cables in order to maintain operation of their mobile electronic devices. Additionally, there exists a need for a charging system that enables multiple users to charge multiple electronic devices simultaneously within shared environments such as offices, retail stores, restaurants, and other public or commercial spaces. Moreover, there exists a need for a wireless charging solution that eliminates the inconvenience of manual alignment, physical contact, or individual charging stations, while enabling devices to charge automatically (i.e., autonomously) as users move through or occupy a space. Finally, there is a long-felt need in the art for a wireless charging station that can be installed in homes, offices, retail stores, and numerous other locations to wirelessly charge electronic devices.

The subject matter disclosed and claimed herein, in one embodiment, comprises a wireless area mobile charging station designed to provide room-scale, automatic wireless charging for a plurality of electronic devices. The station includes a housing configured to be positioned within an enclosed space and enclosing internal electronic components. A power module disposed within the housing is configured to receive electrical power from an external power source and convert the received power into regulated electrical power. A wireless energy transmission module is operatively coupled to the power module and configured to generate wireless electromagnetic energy, which is radiated through one or more antennas to establish a three-dimensional wireless charging region (i.e., field). A control module manages operation of the wireless energy transmission module such that compatible electronic devices positioned within the wireless charging region automatically (i.e., autonomously) receive wireless electrical power without requiring physical contact, wired connections, or user interaction.

In one embodiment, the wireless charging station is configured to monitor the wireless charging region for the presence of compatible electronic devices and to authorize wireless energy delivery upon detecting a receiver associated with such devices. The system may further modulate transmission parameters to control power delivery and may reduce or suspend wireless energy transmission when no compatible devices are detected within the charging region.

In this manner, the wireless area mobile charging system of the present invention overcomes long-standing deficiencies in the art by providing a shared, infrastructure-based charging solution that operates automatically (i.e., autonomously) and seamlessly within everyday environments. The invention improves convenience by eliminating reliance on personal chargers and electrical outlets, supports simultaneous charging of multiple devices, and enables continuous charging during normal occupancy of a space. As a result, the invention provides enhanced accessibility, usability, and efficiency for users while offering a practical wireless charging solution suitable for residential, commercial, and public applications.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a wireless area mobile charging station that includes a housing configured to be positioned within an enclosed space such as a residential, commercial, or public environment. The system includes a power module disposed within the housing, the power module being configured to receive electrical power from an external power source and to condition, convert, and distribute the received electrical power into regulated electrical power for internal system operation. A wireless energy transmission module is operatively coupled to the power module and is configured to generate wireless electromagnetic energy suitable for transmission to electronic devices. At least one antenna is operatively coupled to the wireless energy transmission module and radiates the electromagnetic energy outward from the housing to establish a wireless charging region. A control module is operatively coupled to the power module and the wireless energy transmission module and is configured to control wireless energy transmission such that a plurality of electronic devices automatically (i.e., autonomously) receive wireless electrical power for charging when positioned within the wireless charging region, without requiring physical contact, wired connections, charging pads, or direct user interaction.

In another embodiment, the invention provides a wireless charging station that includes a housing having an upper surface and at least one side surface, the housing being configured to enclose and protect internal electronic components. A power module within the housing is configured to receive electrical power from an external power source and to condition and regulate the electrical power for use by internal components. A wireless energy transmission module is also disposed within the housing and is configured to generate electromagnetic energy for wireless transmission. A first antenna and a second antenna extend from the upper surface of the housing and are operatively coupled to the wireless energy transmission module to transmit the electromagnetic energy into the surrounding environment. A control module manages operation of the wireless energy transmission module and the antennas such that a three-dimensional wireless charging region extending outwardly from the housing is established, thereby enabling compatible electronic devices located within the charging region to automatically (i.e., autonomously) receive wireless electrical power.

In a further embodiment, the invention provides a method for wirelessly charging electronic devices using a wireless charging station positioned within an enclosed space. The method includes receiving electrical power at the wireless charging station from an external power source and converting the received electrical power into regulated electrical power suitable for use by internal components of the station. A transmission profile and one or more safety limits are initialized to define operating parameters for wireless energy transmission. Wireless electromagnetic energy is generated by a wireless energy transmission module and emitted through one or more antennas to establish a wireless charging region within the enclosed space. One or more electronic devices positioned within the wireless charging region automatically (i.e., autonomously) receive wireless electrical power for charging without requiring physical contact, manual alignment, authentication, or user interaction.

In another aspect, the invention provides a method for managing wireless energy transmission in a wireless charging system. The method includes monitoring a wireless charging region for the presence of electronic devices. The system determines the presence of a receiver associated with an electronic device by evaluating electrical or electromagnetic characteristics such as frequency response, resonant behavior, or signaling. Upon determining the presence of a compatible receiver within the wireless charging region, wireless energy delivery is authorized. Transmission of electromagnetic energy is modulated by adjusting one or more transmission parameters to deliver wireless electrical power to the electronic device in a controlled manner.

In some embodiments, the wireless area mobile charging station establishes a wireless charging region that extends beyond a single enclosed space. The wireless charging region extends through a wall or partition separating a first room from a second room. A primary wireless charging region is established within the first room, while a secondary or extended wireless charging region is formed within the second room.

In yet another embodiment, the wireless charging system is configured to manage idle operation to conserve energy and reduce unnecessary electromagnetic emissions. When no compatible electronic devices are detected within the wireless charging region, the system reduces or suspends wireless energy transmission.

In one embodiment, the wireless charging station includes a plurality of indicator elements disposed on the housing. The indicator elements can comprise light-emitting diodes or other visual indicators. The indicator elements are configured to display operational status, charging activity, or power transmission conditions of the wireless charging station.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a wireless charging station of the preset invention in accordance with the disclosed structure;

FIG. 2 illustrates a functional block diagram illustrating an exemplary internal architecture of the wireless area mobile charging system of the present invention in accordance with the disclosed structure;

FIG. 3 illustrates a perspective view showing an exemplary deployment of the wireless area mobile charging station and showing propagation of a wireless charging region in accordance with the disclosed structure;

FIG. 4 illustrates a flow chart depicting steps of operation of the wireless area mobile charging station of the present invention in accordance with the disclosed structure;

FIG. 5 illustrates a flow chart depicting an exemplary method for detecting compatible electronic devices and authorizing wireless energy delivery within a wireless charging region in accordance with the present invention; and

FIG. 6 is a flow diagram illustrating an exemplary method for reducing power consumption and managing idle operation of the wireless area mobile charging station in accordance with the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there exists a long-felt need in the art for an improved charging solution that overcomes the limitations of conventional wired and pad-based charging systems. There is a long-felt need in the art for a charging system that does not require users to locate an electrical outlet or carry personal charging cables in order to maintain operation of their mobile electronic devices. Additionally, there exists a need for a charging system that enables multiple users to charge multiple electronic devices simultaneously within shared environments such as offices, retail stores, restaurants, and other public or commercial spaces. Moreover, there exists a need for a wireless charging solution that eliminates the inconvenience of manual alignment, physical contact, or individual charging stations, while enabling devices to charge automatically (i.e., autonomously) as users move through or occupy a space. Finally, there is a long-felt need in the art for a wireless charging station that can be installed in homes, offices, retail stores, and numerous other locations to wirelessly charge electronic devices.

The present invention, in one exemplary embodiment, is a method for wirelessly charging electronic devices using a wireless charging station positioned within an enclosed space. The method includes receiving electrical power at the wireless charging station from an external power source and converting the received electrical power into regulated electrical power suitable for use by internal components of the station. A transmission profile and one or more safety limits are initialized to define operating parameters for wireless energy transmission. Wireless electromagnetic energy is generated by a wireless energy transmission module and emitted through one or more antennas to establish a wireless charging region within the enclosed space. One or more electronic devices positioned within the wireless charging region automatically (i.e., autonomously) receive wireless electrical power for charging without requiring physical contact, manual alignment, authentication, or user interaction.

Reference will now be made in detail to the present preferred embodiments of the invention, examples of which are illustrated in the accompanying drawings. Wherever possible, the same reference numerals are used in the drawings and the description to refer to the same or like parts.

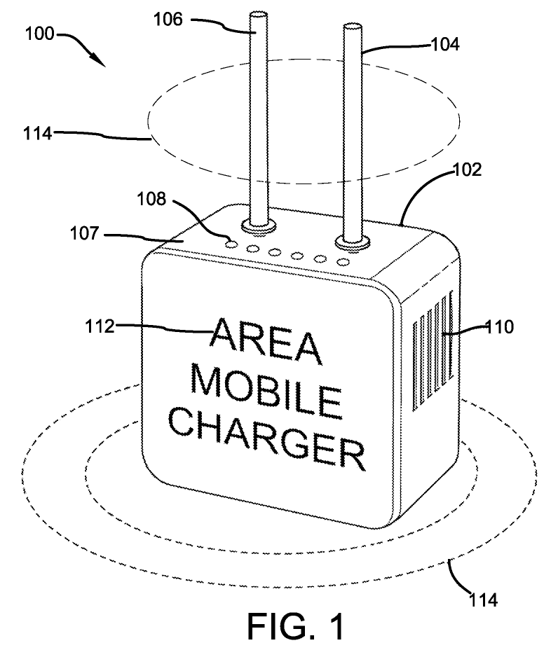

Referring initially to the drawings, FIG. 1 illustrates a perspective view of wireless charging station of the preset invention in accordance with the disclosed structure. The wireless charging station 100 of the present invention is designed as a wireless, room-scale charging station configured to automatically (i.e., autonomously) supply power to a plurality of electronic mobile devices within an operating radius thereof. More specifically, the wireless charging station 100 is configured in a router-like form factor and operates to broadcast energy wirelessly such that smartphones, tablets, and other compatible electronic devices begin charging upon entering a coverage or operating area of the station 100, without requiring charging cables, charging pads, or direct physical contact with a power source.

The wireless charging station 100 includes a housing 102 having a generally rectangular form with rounded edges. The housing 102 can be formed in any suitable geometric shape and can be manufactured in any color or finish. The housing 102 is configured to enclose and protect internal electronic components from environmental exposure and physical damage. A first antenna 104 and a second antenna 106 extend upwardly from an upper surface 107 of the housing 102. Each of the antennas 104, 106 is configured to transmit wireless electromagnetic energy, and the antennas 104, 106 can operate independently or cooperatively to generate a wireless charging field 114.

A plurality of indicator elements 108, which can comprise light-emitting diodes (LEDs) or other visual indicators, are disposed on the upper surface 107 of the housing 102. The indicator elements 108 are configured to display operational status, charging activity, or power transmission conditions of the charging unit (i.e., station) 102, as described later in the disclosure. A plurality of ventilation openings 110 are formed on at least one side surface of the housing 102 to facilitate heat dissipation from internal electronic components. The housing 102 may further include identifying indicia 112, such as a product name, trademark, or functional label.

The wireless charging station 100, also referred to herein as a wireless area mobile charging system, is configured to generate a three-dimensional wireless charging region 114. The charging region 114 extends outwardly from the charging unit (i.e., station) 102 and defines an area within which compatible electronic devices (not shown in FIG. 1) automatically (i.e., autonomously) receive wireless electrical power for charging. The charging region 114 can extend substantially around and above the charging unit (i.e., station) 102, forming a generally circular, spherical, or hemispherical coverage zone.

It will be understood that the configuration, number, orientation, and placement of the antennas 104, 106, indicator elements 108, ventilation openings 110, and charging region 114 can vary without departing from the scope of the invention.

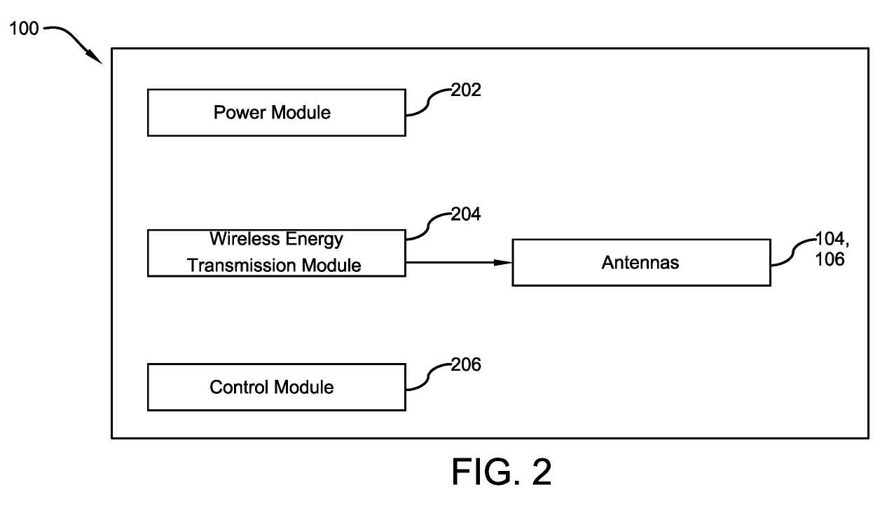

FIG. 2 illustrates a functional block diagram illustrating an exemplary internal architecture of the wireless area mobile charging system of the present invention in accordance with the disclosed structure. As shown in FIG. 2, the wireless charging station 100 comprises a power module 202, a wireless energy transmission module 204, and a control module 206, each operatively disposed within the housing 102 of the station 100 (shown in FIG. 1).

The power module 202 is configured to receive electrical power from an external power source (such as a conventional wall mounted AC supply) and to condition, convert, and distribute the electrical power to one or more internal components of the wireless charging system 100. The power module 202 can include, without limitation, an alternating current (AC) to direct current (DC) converter, voltage regulation circuitry, and power management components.

The wireless energy transmission module 204 is operatively coupled to the power module 202 and is configured to generate wireless electromagnetic energy suitable for transmission to one or more electronic devices. The wireless energy transmission module 204 is further operatively coupled to one or more antennas 104, 106, which are configured to radiate the generated electromagnetic energy into the surrounding environment to form the wireless charging region 114 described with reference to FIG. 1.

The control module 206 is operatively coupled to at least the power module 202 and the wireless energy transmission module 204. The control module 206 can comprise one or more processors, microcontrollers, or logic circuits and is configured to control operation of the wireless charging system 100, including but not limited to regulating power output, managing wireless energy transmission, and monitoring system status.

It will be understood that the functional modules illustrated in FIG. 2 represent logical components and that the functions performed by the power module 202, wireless energy transmission module 204, and control module 206 can be implemented using discrete hardware components, integrated circuits, firmware, software, or any combination thereof. Additionally, the configuration and interconnection of the modules can vary without departing from the scope of the present invention.

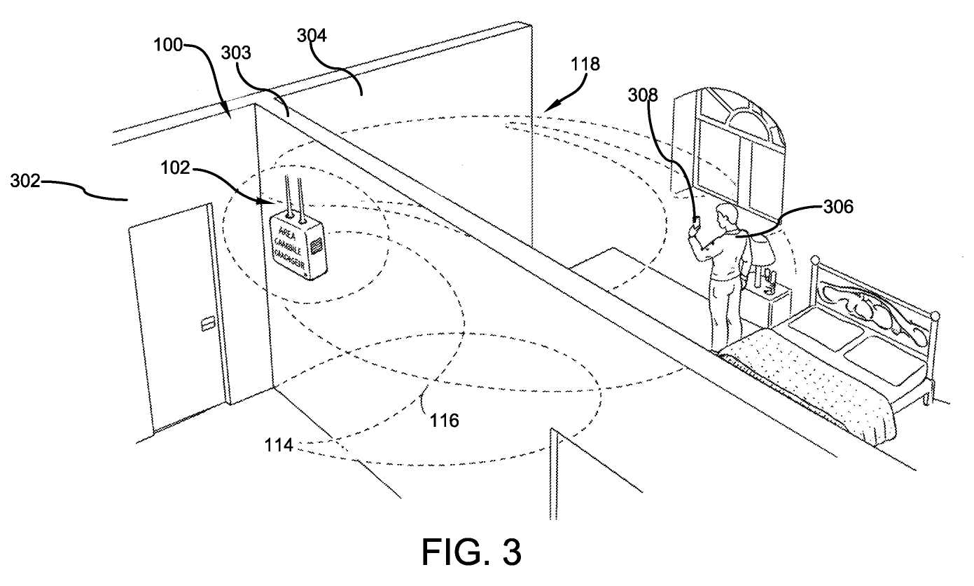

FIG. 3 illustrates a perspective view showing an exemplary deployment of the wireless area mobile charging station and showing propagation of a wireless charging region in accordance with the disclosed structure. As shown in FIG. 3, the wireless charging station 100 including a housing 102 is positioned within a first room 302, which may represent a primary room such as a living room, hallway, or office space. The wireless charging station 100 is mounted on or adjacent to a wall surface within the first room 302.

The first room 302 is separated from a second room 304 by a wall or partition 303, which can comprise drywall, masonry, or other building materials. The second room 304 may represent an adjacent space such as a bedroom, office, or other enclosed area. The wireless charging station 100 is configured to generate a wireless charging region 114, illustrated by dashed lines, which extends outwardly within the first room 302 to define a primary wireless charging region 116. The wireless charging region 114 further extends through the wall or partition into the second room 304, thereby defining a secondary or extended wireless charging region 118.

As further shown in FIG. 3, a user 306 is located within the second room 304 and is holding an electronic device 308, such as a smartphone or other mobile electronic device. The electronic device 308 is configured to receive wireless electrical power from the wireless charging station 100 when positioned within the extended wireless charging region 118, thereby enabling the device 308 to charge automatically (i.e., autonomously) despite being located in a room different from the wireless charging station 100.

The extent of the wireless charging regions can vary based on environmental conditions, wall materials, system configuration, transmission power, and the number or location of electronic devices. It will be understood that the arrangement of rooms 302, 304, the placement of the wireless charging station 100, and the illustrated charging regions are exemplary only, and that the wireless charging station 100 can be deployed in a wide variety of residential, commercial, or public environments without departing from the scope of the invention.

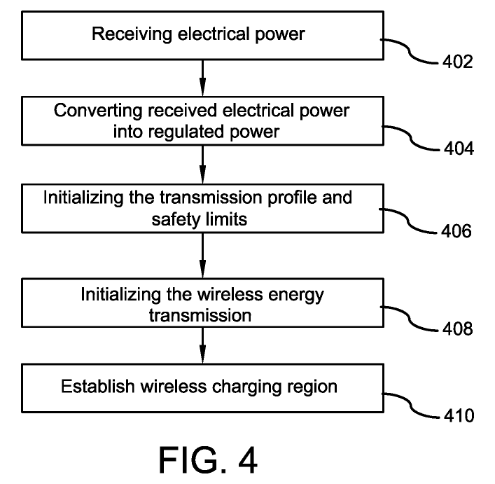

FIG. 4 illustrates a flow chart depicting steps of operation of the wireless area mobile charging station of the present invention in accordance with the disclosed structure. Initially, electrical power is received by the wireless charging station 100 from an external power source (Step 402). The received electrical power can comprise alternating current (AC) power or another suitable power supply.

Then, the received electrical power is converted into regulated electrical power suitable for use by internal components of the wireless charging station (Step 404). The conversion can include rectification, voltage regulation, and power conditioning and is performed by the power module 202.

Thereafter, a transmission profile and one or more safety limits are initialized by the control module (Step 406). The transmission profile may define operating parameters such as transmission frequency, power level, duty cycle, and coverage characteristics, while the safety limits may define maximum allowable electromagnetic emission levels or exposure thresholds. At step 408, wireless energy transmission is initialized by enabling the wireless energy transmission module and associated antennas of the wireless charging station.

Finally, the electromagnetic energy is emitted into the surrounding environment to establish a wireless charging region within which compatible electronic devices may receive wireless electrical power for charging (Step 410). The steps illustrated in FIG. 4 can be performed in the order shown or in any suitable order, and one or more steps can be combined, omitted, or repeated without departing from the scope of the invention. Additionally, the method of FIG. 4 can be performed automatically (i.e., autonomously) without user intervention.

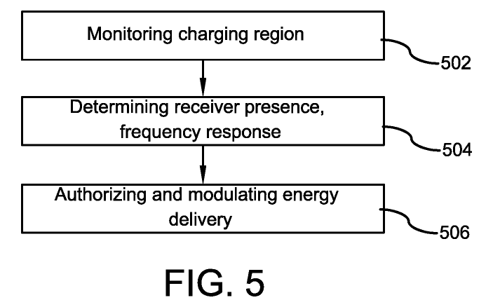

FIG. 5 illustrates a flow chart depicting an exemplary method for detecting compatible electronic devices and authorizing wireless energy delivery within a wireless charging region in accordance with the present invention. As shown in FIG. 5, initially, the wireless charging station 100 monitors the wireless charging region for the presence of one or more electronic devices (Step 502). The monitoring can be continuous or periodic and can be performed using one or more sensing, signaling, or detection techniques.

At step 504, the wireless charging station 100 determines the presence of a receiver associated with an electronic device within the charging region. The determination can include evaluating a frequency response, resonant behavior, handshake signal, or other electrical or electromagnetic characteristics indicative of a compatible wireless energy receiver.

Upon determining the presence of a compatible receiver, the wireless charging system authorizes wireless energy delivery and modulates the transmitted electromagnetic energy (Step 506). The modulation can include adjusting transmission parameters such as power level, frequency, phase, duty cycle, or beam direction to efficiently and safely deliver electrical power to the detected electronic device.

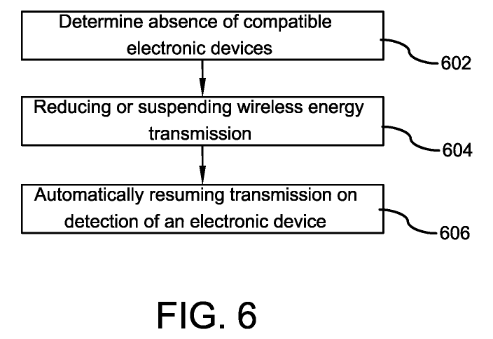

FIG. 6 is a flow diagram illustrating an exemplary method for reducing power consumption and managing idle operation of the wireless area mobile charging station in accordance with the present invention. Initially, the wireless charging station 100 determines that no compatible electronic devices are detected within the wireless charging region (Step 602). The determination can be based on an absence of receiver signals, frequency responses, handshake signals, or other indicators associated with compatible electronic devices.

In response to determining that no electronic devices are present within the charging region, the wireless charging station reduces or suspends wireless energy transmission (Step 604). Reducing or suspending transmission can include lowering transmission power, disabling one or more antennas, or placing one or more system components into a low-power or standby mode to conserve energy and reduce unnecessary electromagnetic emissions.

The wireless charging station automatically (i.e., autonomously) resumes wireless energy transmission upon detecting the presence of a compatible electronic device within the charging region (Step 606). The resumption of transmission may occur without user intervention and can include reinitializing transmission parameters to reestablish the wireless charging region.

In an exemplary use scenario, the wireless charging station 100 is installed within an enclosed space, such as a residential room, office, retail environment, hospitality venue, or other defined area. Upon installation and activation, the wireless charging station 100 establishes a wireless charging region that extends throughout at least a portion of the enclosed space. The charging region can be continuous or segmented and can vary in size, shape, or intensity based on system configuration, environmental conditions, and physical structures within the space.

During normal occupancy of the enclosed space, a plurality of users may enter the space while carrying electronic devices, such as smartphones, tablets, wearable devices, or other portable electronic equipment. When such electronic devices are positioned within the wireless charging region, the devices automatically (i.e., autonomously) receive wireless electrical power from the charging station without requiring physical connection, manual alignment, user authentication, or user interaction with the charging station. Wireless charging may occur continuously or intermittently while the users remain within the enclosed space.

As users move within the space or remain present for a period of time, the electronic devices continue to receive wireless electrical power sufficient to charge internal energy storage components. When the users subsequently exit the enclosed space, the electronic devices are charged or partially charged, and the users depart without having interacted with the wireless charging station or employed conventional charging accessories such as cables or charging pads.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “wireless area mobile charging system”, “wireless area mobile charging station”, “wireless charging station”, and “station” are interchangeable and refer to the wireless area mobile charging station 100 of the present invention.

Notwithstanding the forgoing, the wireless area mobile charging station 100 of the present invention can be of any suitable configuration as is known in the art without affecting the overall concept of the invention, provided that it accomplishes the above stated objectives. One of ordinary skill in the art will appreciate that the wireless area mobile charging station 100 shown in the FIGS. are for illustrative purposes only, and that many other configurations of the wireless area mobile charging station 100 are well within the scope of the present disclosure. Although the dimensions of the wireless area mobile charging station 100 are important design parameters for user convenience, the wireless area mobile charging station 100 can be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wireless charging station comprising:
a wireless charging station;
at least two antennas; and
a plurality of indicator elements;
wherein said wireless charging station comprises a power module, a wireless energy transmission module, and a control module each operatively disposed within a housing of said wireless charging station;
wherein said at least two antennas are configured to transmit wireless electromagnetic energy;
wherein said at least two antennas operate to generate a three-dimensional wireless charging field;
wherein said plurality of indicator elements comprise light-emitting diodes (LEDs) disposed on an upper surface of said housing of said wireless charging station;
wherein said indicator elements are configured to display operational status, charging activity, and power transmission conditions of said wireless charging station; and
further wherein said wireless charging station is configured to generate said three-dimensional wireless charging field extending outwardly from said wireless charging station.

2. The wireless charging station of claim 1, wherein said three-dimensional wireless charging field defines an area within which compatible electronic devices autonomously receive wireless electrical power for charging.

3. The wireless charging station of claim 2, wherein said three-dimensional wireless charging field extends around and above said wireless charging station forming a spherical coverage zone.

4. The wireless charging station of claim 3, wherein said housing comprises a plurality of ventilation openings formed on at least one side surface of said housing to facilitate heat dissipation from internal electronic components.

5. The wireless charging station of claim 4, wherein said power module is configured to receive electrical power from an external power source and to distribute the electrical power to said wireless charging system.

6. The wireless charging station of claim 5, wherein said wireless energy transmission module is operatively coupled to said power module and is configured to generate said wireless electromagnetic energy for transmission to one or more of the electronic devices.

7. The wireless charging station of claim 6, wherein said wireless energy transmission module is operatively coupled to said at least two antennas for radiating said three-dimensional wireless charging field into the surrounding environment.

8. The wireless charging station of claim 7, wherein said defined area is an interior space of a first room and an interior space of a second room.

9. A method of wireless charging of mobile electronic devices, the method comprising the steps of:
providing a wireless charging station, at least two antennas, a plurality of indicator elements, a power module, a wireless energy transmission module, and a control module, wherein said wireless charging station comprises said power module, said wireless energy transmission module, and said control module each operatively disposed within a housing of said wireless charging station;
receiving electrical power from an external power source by said power module;
distributing the electrical power to said wireless charging system;
transmitting wireless electromagnetic energy through said wireless energy transmission module and said at least two antennas;
generating a three-dimensional wireless charging field through said wireless energy transmission module and said at least two antennas;
wherein said plurality of indicator elements comprise light-emitting diodes (LEDs) disposed on an upper surface of said housing of said wireless charging station;
displaying operational status, charging activity, and power transmission conditions of said wireless charging station with said plurality of indicator elements;
generating said three-dimensional wireless charging field extending outwardly from said wireless charging station with said wireless charging station;
autonomously receiving said three-dimensional wireless charging field by the mobile electronic devices; and
charging the mobile electronic devices while the mobile electronic devices are within said three-dimensional wireless charging field.

10. The method of wireless charging of mobile electronic devices of claim 9, wherein said three-dimensional wireless charging field defines an area within which the mobile electronic devices autonomously receive wireless electrical power for charging.

11. The method of wireless charging of mobile electronic devices of claim 10, wherein said three-dimensional wireless charging field extends around and above said wireless charging station forming a spherical coverage zone.

12. The method of wireless charging of mobile electronic devices of claim 11, wherein said wireless energy transmission module is operatively coupled to said power module and is configured to generate said wireless electromagnetic energy for transmission to one or more of the electronic devices.

13. The method of wireless charging of mobile electronic devices of claim 12, wherein said wireless energy transmission module is operatively coupled to said at least two antennas for radiating said three-dimensional wireless charging field into the surrounding environment.

14. The method of wireless charging of mobile electronic devices of claim 13, wherein said defined area is an interior space of a first room and an interior space of a second room, further wherein said first room is separated from said second room by a wall.

15. The method of wireless charging of mobile electronic devices of claim 14, further comprising the steps of:
detecting compatible electronic devices, wherein said detecting compatible electronic devices comprises one or more selected from the group consisting of evaluating a frequency response, a resonant behavior, and a handshake signal; and
authorizing said wireless electromagnetic energy for transmission to one or more of said compatible electronic devices within said three-dimensional wireless charging field.

16. The method of wireless charging of mobile electronic devices of claim 15, further comprising the steps of:
detecting no said compatible electronic devices within said three-dimensional wireless charging field through one or more selected from the group consisting of lack of said frequency response, lack of said resonant behavior, and lack of said handshake signal; and
suspending transmission of said wireless electromagnetic energy.

17. The method of wireless charging of mobile electronic devices of claim 16, further comprising the step of autonomously resuming transmission of said wireless electromagnetic energy upon detecting the presence of said compatible electronic devices within said three-dimensional wireless charging field.

18. A method of wireless charging of electronic devices, the method comprising the steps of:
providing a wireless charging station, at least two antennas, a plurality of indicator elements, a power module, a wireless energy transmission module, and a control module, wherein said wireless charging station comprises said power module, said wireless energy transmission module, and said control module each operatively disposed within a housing of said wireless charging station;
receiving electrical power from an external power source by said power module;
distributing the electrical power to said wireless charging system;
transmitting wireless electromagnetic energy through said wireless energy transmission module and said at least two antennas;
generating a three-dimensional wireless charging field through said wireless energy transmission module and said at least two antennas;
wherein said plurality of indicator elements comprise light-emitting diodes (LEDs) disposed on an upper surface of said housing of said wireless charging station;
displaying operational status, charging activity, and power transmission conditions of said wireless charging station with said plurality of indicator elements;
generating said three-dimensional wireless charging field extending outwardly from said wireless charging station with said wireless charging station;
detecting compatible electronic devices, wherein said detecting compatible electronic devices comprises one or more selected from the group consisting of evaluating a frequency response, a resonant behavior, and a handshake signal;
authorizing said wireless electromagnetic energy for transmission to one or more of said compatible electronic devices within said three-dimensional wireless charging field;
autonomously receiving said three-dimensional wireless charging field by said compatible electronic devices; and
charging said compatible electronic devices while said compatible electronic devices are within said three-dimensional wireless charging field.

19. The method of wireless charging of mobile electronic devices of claim 18, further comprising the steps of:
detecting no said compatible electronic devices within said three-dimensional wireless charging field through one or more selected from the group consisting of lack of said frequency response, lack of said resonant behavior, and lack of said handshake signal; and
suspending transmission of said wireless electromagnetic energy.

20. The method of wireless charging of mobile electronic devices of claim 19, further comprising the step of autonomously resuming transmission of said wireless electromagnetic energy upon detecting the presence of said compatible electronic devices within said three-dimensional wireless charging field.
